(19) United States
(12) Patent Application Publication
(10) Pub. No.: US 2010/0070332 A1
(43) Pub. Date: Mar. 18, 2010

(54) METHOD FOR EVALUATING PROJECT

(75) Inventor: R. MAHESH, Bangalore (IN)

Correspondence Address: CANTOR COLBURN, LLP, 20 Church Street, 22nd Floor, Hartford, CT, 06103, US

(73) Assignee: INFOSYS TECHNOLOGIES LIMITED, Bangalore (IN)

(21) Appl. No.: 12/558,811

(22) Filed: Sep. 14, 2009

(30) Foreign Application Priority Data
Sep. 15, 2008 (IN) 2232/CHE/2008

(51) Int. Cl. G06Q 10/00

(52) U.S. Cl. 705/9; 705/7; 705/10

(57) ABSTRACT

The present invention provides a method, system and computer program product for evaluating a project. The project includes one or more tasks. A plurality of stakeholders is assigned to each task. The stakeholders include a task owner and one or more external stakeholders. Each task is performed by the corresponding task owner. A plurality of ratings is assigned to each task by the corresponding task owner and the corresponding external stakeholders, based on one or more evaluation criteria. An evaluation index indicating the quality of the project is determined based on the ratings.

### BACKGROUND

The present invention relates to the field of project management. More specifically, it relates to a system and method for determining the quality of a project.

Typical technology transformation programs in an industry require huge monetary investment. Examples of such technology transformation programs include installation of a new Information Technology (IT) infrastructure. The installation may include multiple tasks. The tasks are performed by the corresponding task owners. Sometimes, in spite of such huge investment, the end results of such transformation programs are not up to the mark.

Currently, such programs are tracked through software tools such as Project® by Microsoft®. Project® assigns a resource to the task and estimates the work. It also calculates the cost of the task performed. Project® graphically represents various data related to a project and tracks the project over its lifespan. However, Project® does not provide a 360 degree evaluation of the tasks performed during the course of the project. Further, there may not be transparency among the stakeholders of the tasks. For example, for the same task, the satisfaction levels of the one or more stakeholders and the task owner may be different. The difference in the satisfaction levels indicates disconnect between the one or more stakeholders and the task owner. Due to such disconnect in the satisfaction levels of the task owner and the external stakeholders, the transformation program may fail.

In light of the foregoing, there is a need for an improved method for evaluating a project. Further, it is necessary to determine the quality of the project for improving the performance level and reducing disconnect.

### SUMMARY

An object of the invention is to evaluate a project.

Another object of the invention is to determine the quality of the project.

Yet another object of the invention is to graphically represent the ratings assigned by multiple stakeholders corresponding to one or more tasks of the project.

Still another object of the invention is to alert the stakeholders, based on the quality of the project.

To achieve the objectives mentioned above, the invention provides a system, method and computer program product for evaluating a project having one or more tasks. A plurality of stakeholders is assigned to each task. The stakeholders include a task owner and one or more external stakeholders corresponding to each of the tasks.

A plurality of ratings is assigned to each task by the corresponding task owner and the corresponding external stakeholders. The ratings corresponding to a task indicate its evaluation. An average of the ratings assigned by the external stakeholders is calculated for each task. A variation between the average value and the rating assigned by the task owner is determined for each task. In an embodiment of the invention, the variation is a difference between the average value and the rating assigned by the task owner. A ratio of the variation to the average rating is calculated for each task. An average of the ratio corresponding to each task is calculated. The average of the ratio is an evaluation index for the project. The evaluation index indicates the quality of the project.

The system described above has a number of advantages. The system calculates the quality of the project. The evaluation index indicates a need for improvement in the quality of the task. The system provides transparency among the plurality of stakeholders corresponding to a task. Further, the system alerts the stakeholders, based on the evaluation index.

### BRIEF DESCRIPTION OF THE DRAWINGS

The various embodiments of the invention will hereinafter be described in conjunction with the appended drawings, provided to illustrate and not to limit the invention, wherein like designations denote like elements, and in which:

FIG. 1 is a flowchart of a method for determining the quality of the project, in accordance with various embodiments of the invention;

FIG. 2 is a flowchart of a method for determining the quality of the project, in accordance with an embodiment of the invention;

FIG. 3a is a table depicting a calculation of an evaluation index for a project, in accordance with an exemplary embodiment of the invention;

FIG. 3b is a graphical representation of the ratio of a variation to an average rating corresponding to each task, in accordance with the exemplary embodiment of the invention;

FIGS. 4a to 4e illustrates a graphical representation of the ratings assigned by a task owner and one or more external stakeholders, in accordance with another exemplary embodiment of the invention;

FIG. 5 is a block diagram of a system for determining the quality of the project, in accordance with various embodiments of the invention; and

FIG. 6 is a block diagram of a system for determining the quality of the project, in accordance with an embodiment of the invention.

### DESCRIPTION OF VARIOUS EMBODIMENTS

The invention describes a method, system and computer program product for evaluating a project. The project includes one or more tasks. For example, the project may be a technology transformation program such as an installation of a new IT infrastructure, an installation of a payment system, or an implementation of a new Human Resource (HR) policy for an organization. The technology transformation program, such as the installation of a new IT infrastructure, may include various tasks, such as understanding the requirements of the organization, development and customization of various IT infrastructural elements, such as servers, databases, software, and so forth, various documentations related to the IT infrastructural elements, installation of the IT infrastructural elements in the organization, training related to the use and functioning of the IT infrastructural elements, and so forth. A plurality of stakeholders is assigned to each task. The stakeholders include a task owner and one or more external stakeholders. Each task is performed by the corresponding task owner. The external stakeholders may include a client for whom the project is performed and a system integrator. The system integrator is responsible for the entire delivery of various technology transformation programs. For example, the system integrator may be a hardware provider, an HR service provider, a payment system vendor, or a vendor who installs the new IT infrastructure for the client. The tasks are evaluated by the task owner and the corresponding stakeholders. The system is used for determining the quality of the project.

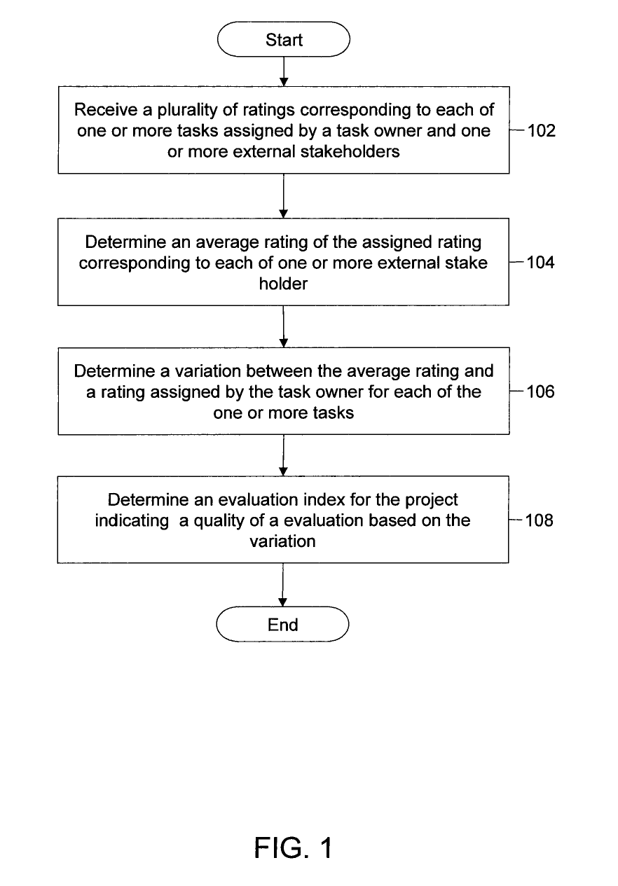

FIG. 1 is a flowchart depicting a method for determining the quality of the project, in accordance with various embodiments of the invention.

At step 102, a plurality of ratings corresponding to each task is assigned. The ratings corresponding to a task are assigned by the corresponding task owner and the corresponding external stakeholders. The ratings are assigned, based on the one or more evaluation criteria. The evaluation criteria include, but are not limited to, scope, time duration, cost and quality of the performed task.

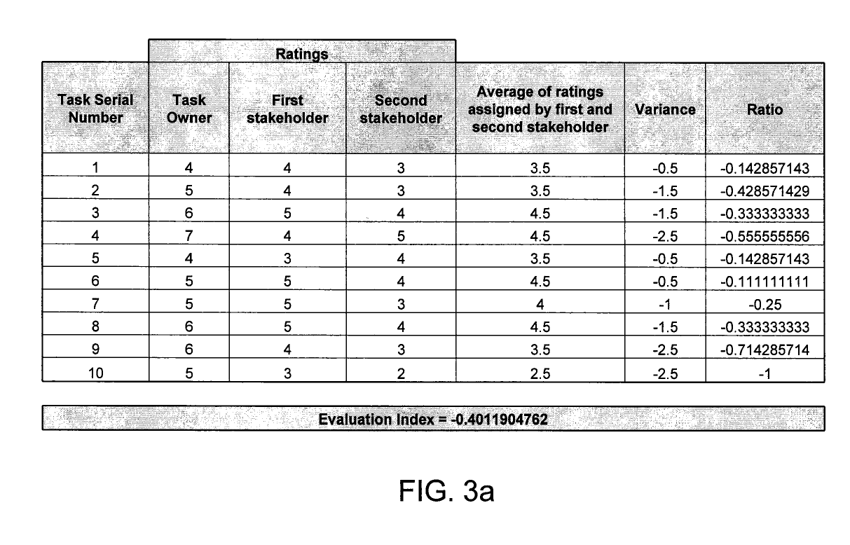

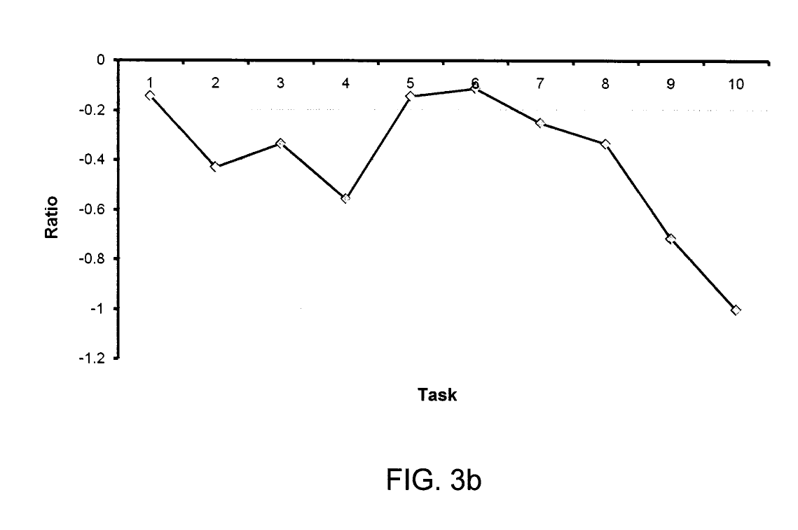

At step 104, an average of the ratings assigned by the external stakeholders is determined. The average rating is determined for each of the tasks. The determination of the average rating is further explained in detail as an exemplary embodiment of the invention in conjunction with FIG. 3a.

At step 106, variation between the average rating and the rating assigned by the task owner is determined. The variation is determined for each of the tasks. In an embodiment of the invention, the variation is a numerical difference between the average rating and the rating assigned by the external stakeholders. The determination of the variation is further explained in detail as the exemplary embodiment of the invention in conjunction with FIG. 3a.

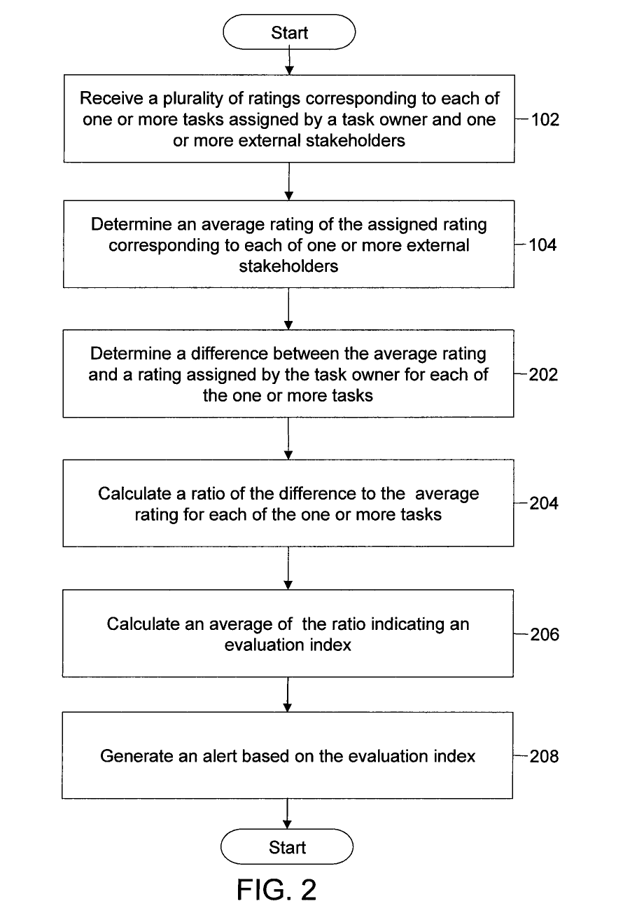

At step 108, an evaluation index for the project is determined. The evaluation index is determined, based on the calculated variation for each of the tasks. The evaluation index indicates the quality of the project. The evaluation also indicates disconnect between the evaluations performed by the task owners and the external stakeholders. Further, the evaluation index indicates the need for improvement in the quality of work. Furthermore, the determination of the evaluation index is explained in detail in conjunction with steps 202, 204 and 206 of FIG. 2.

FIG. 2 is a flowchart of a method for determining the quality of the project, in accordance with an embodiment of the invention.

As explained in FIG. 1, a plurality of ratings corresponding to each task is assigned. The ratings corresponding to a task of the one or more tasks are assigned by the corresponding task owner and the corresponding external stakeholders, based on one or more evaluation criteria. An average of the ratings assigned by the external stakeholders is determined. This has been further explained in detail in conjunction with steps 102 and 104 of FIG. 1.

At step 202, the difference between the average rating and the rating assigned by the task owner is determined. The determination of the difference is explained in detail as an exemplary embodiment of the invention in conjunction with FIG. 3a.

At step 204, a ratio of the variation to the average rating is calculated for each of the tasks. The calculation of the variation is further explained in detail as the exemplary embodiment of the invention in conjunction with FIG. 3a.

At step 206, an average of all the calculated ratios is determined. In an embodiment of the invention, this average of ratios is the evaluation index. The evaluation index indicates the quality of the project. The evaluation also indicates disconnect between the evaluations performed by the task owners and the external stakeholders. Further, the evaluation index indicates the need for improvement in the quality of work. Furthermore, the calculation of the evaluation index is explained in detail as the exemplary embodiment of the invention in conjunction with FIG. 3a.

At step 208, an alert is generated, based on the evaluation index. The alert is generated when the evaluation index deviates from zero to more than a predefined value. The alert indicates that there is a large disconnect between the evaluations performed by the task owner and the external stakeholders. In an embodiment of the invention, the alert will be generated if the evaluation index becomes greater than ±1.

FIG. 3a is a table depicting a calculation of an evaluation index for a project, in accordance with an exemplary embodiment of the invention. The exemplary project considered in FIG. 3a and FIG. 3b includes 10 tasks. Each of the 10 tasks is evaluated by the corresponding task owner and the corresponding external stake holders. The evaluation is performed, based on various evaluation criteria.

In various embodiments of the invention, the evaluation criteria include the scope, time duration, cost, quality of the performed task, and so forth. In this example, the ratings may be assigned on a scale of one to seven. Seven is the highest rating indicating best quality work and one is the lowest rating indicating poor quality work. However, it may be apparent to any person skilled in the art that the rating scale may vary from project to project and may be jointly decided by the task owners and the external stakeholders.

The following paragraphs enlist the definitions of each rating, as considered in this example.

The rating of seven is assigned if the task has been performed according to the agreed scope, timeline, cost and acceptable quality of work. The rating of seven indicates that the evaluator is extremely satisfied.

The rating of six is assigned if any of the criteria such as the scope, time duration, cost and quality of the task is compromised with, within an acceptable limit and the reason for the compromise is explainable. The rating of six indicates that the evaluator is satisfied.

The rating of five is assigned if any of the criteria such as the scope, time duration, cost and quality of the task is compromised with beyond an acceptable limit and the explanation for the compromise is not satisfactory. The rating of five indicates that the evaluator evaluates the task to be less than satisfactory.

The rating of four is assigned if more than one evaluation criteria such as the scope, time duration, cost and quality of the task are compromised with, and the delivery of the task is not satisfactory. The rating of four indicates that the evaluator's satisfaction is average.

The rating of three is assigned if more than one evaluation criteria such as the scope, time duration, cost and quality of the task are compromised with, the delivery of the task is not satisfactory, and there is no commitment on improvement in the work in future. The rating of three indicates that the evaluator's satisfaction level is less than average.

The rating of two is assigned if more than one evaluation criteria such as the scope, time duration, cost and quality of the task are compromised with, the delivery of the task is not satisfactory, there is no commitment on improvement in the work in future, and the response from the task owner or the stakeholders is not satisfactory. The rating of two indicates that the evaluator is satisfied below average.

The rating of one is assigned if more than one evaluation criteria such as the scope, time duration, cost and quality of the task are compromised with, the delivery of the task is not satisfactory, there is no improvement in the quality of the task since the previous evaluation, the response from the task owner or the stakeholders is not satisfactory, and the task is performed incorrectly. The rating of one indicates that the evaluator is poorly satisfied.

The ratings are assigned to each of the 10 tasks, based on the evaluation criteria mentioned above. As shown in FIG. 3a, the first column of the table indicates the serial numbers of the tasks. The ‘Task Owner’ column includes the rating assigned to each of the tasks by the corresponding task owner. The ‘First stakeholder’ column includes the rating for each task assigned by the first stakeholder corresponding to the task. The first stakeholder may be the client for whom the task is performed. The ‘Second stakeholder’ column includes the rating for each task assigned by the second stakeholder corresponding to the task. The second stakeholder may be a system integrator. As explained earlier, the system integrator is responsible for the entire delivery of various technology transformation programs. The first stakeholder and the second stakeholder are external stakeholders. The column next to the ‘Second stakeholder’ column includes the average rating of the ratings assigned by the first stakeholder and the second stakeholder. The ‘Variance’ column includes a variance between the average rating and the rating assigned by the task owner corresponding to each task. In the example above, the variation is a numerical difference between the average rating and the rating assigned by the task owner corresponding to each task. The last column includes a ratio of the calculated variance to the average rating for each task.

For the first task, the ratings assigned by the corresponding task owner, the first stakeholder and the second stakeholder are four, four and three, respectively. The average of the ratings assigned by the first and the second stakeholder is 3.5. The difference between the average rating and the rating assigned by the task owner is 0.5. The ratio of the variance to the average rating for the first task is 0.142857143.

Similarly, an average rating, a variance and a ratio of the variance to the average rating is calculated for each of the 10 tasks. The results of the calculations are depicted in a table.

Finally, an average value of the ratios, as depicted in the last column, is calculated. The average value is calculated as 0.4011904762. This average value is the evaluation index for the project. Therefore, for this project, the evaluation index is 0.4011904762. The zero value of the evaluation index indicates the highest quality of the project and that there is no disconnect between the evaluations performed by the task owners and the external stakeholders. The calculated evaluation index for this project is acceptable because the evaluation index is close to zero. The maximum limit of the evaluation index is ±6, which indicates the worst quality of the project. The evaluation index of the value ±6 indicates that there is a large disconnect between the evaluations performed by the task owners and the external stakeholders.

FIG. 3b is a graphical representation of the ratio of the variation to the average rating corresponding to each task, in accordance with the exemplary embodiment of the invention.

The graphical representation depicts a line chart of the ratio corresponding to each task. The horizontal axis of the line chart represents task numbers. The vertical axis of the line chart represents the ratio. The task numbers are mentioned in the first column titled ‘Task Serial Number’ and the ratio are mentioned in the last column titled ‘Ratio’ in the table of FIG. 3a. It may be apparent to any person skilled in the art that the graphical representation includes various types of charts, such as, column chart, bar chart and so forth.

The graphical representation of the ratio corresponding to each task enables the senior-level management to quickly analyze the situation without referring to details of each task.

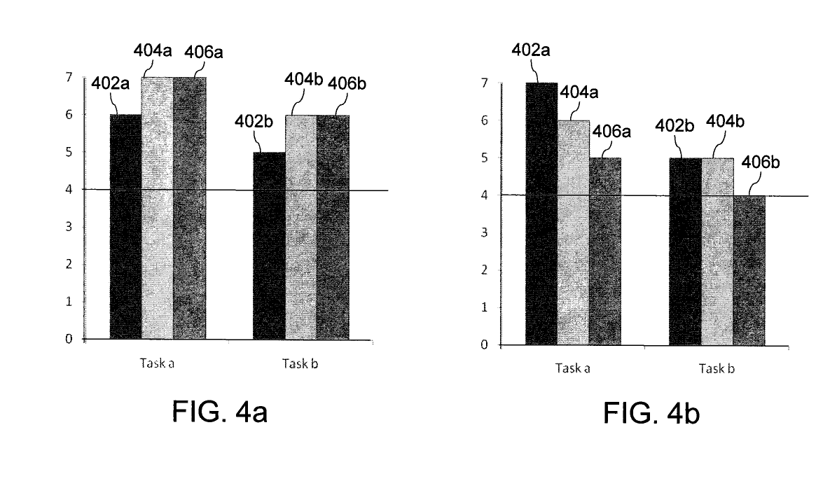

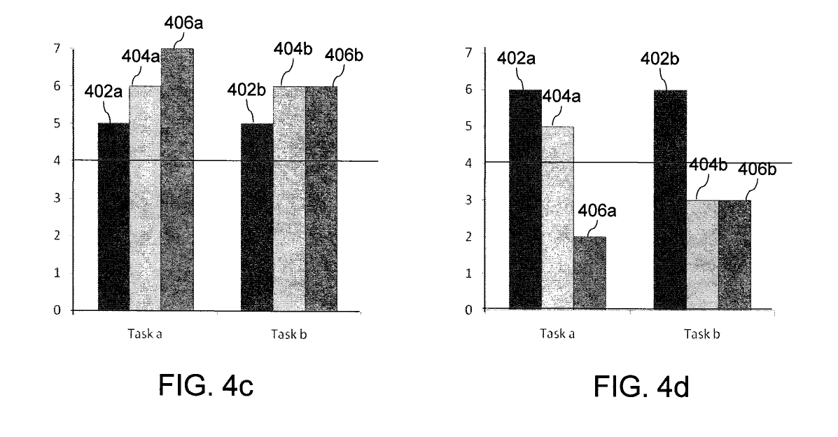

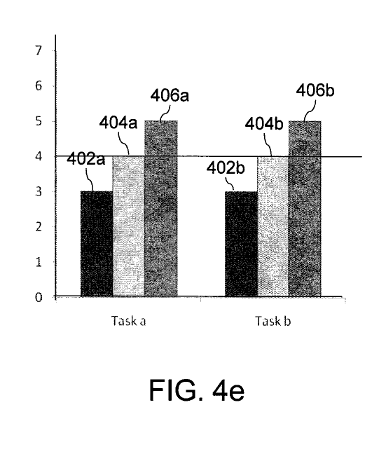

FIGS. 4a to 4e illustrates a graphical representation of the ratings assigned by a task owner and one or more external stakeholders, in accordance with another exemplary embodiment of the invention. The graphical representation depicts the evaluations for two tasks, such as task A and task B. Ratings 402a and 402b are assigned by the task owners corresponding to task A and task B, respectively. Ratings 404a and 404b are assigned by the first external stakeholder corresponding to task A and task B, respectively. Ratings 406a and 406b are the ratings assigned by the second external stakeholder corresponding to task A and task B, respectively. Ratings 402a, 402b, 404a, 404b, 406a and 406b are assigned, based on various evaluation criteria. The evaluation criteria are further explained in detail in conjunction with FIG. 3.

In FIG. 4a, the ratings assigned to task A by the corresponding task owner, the first external stakeholder and the second external stakeholder are six, seven and seven, respectively.

The graphical representation depicts an ideal situation in which the first external stakeholder, the second external stakeholder and the task owner have rated task A almost equally and well above the reference point. Such a situation indicates that the disconnect between the evaluations performed by the task owner and the external stakeholders is minimal.

In FIG. 4b, the ratings assigned to task A by the corresponding task owner, the first external stakeholder and the second external stakeholder are seven, six and five, respectively.

This graphical representation depicts a situation of concern because the task owner corresponding to task A has rated the task high at the rating of seven, while the first external stakeholder and the second external stakeholder have rated task A differently and lower than the rating assigned by the task owner.

In FIG. 4c, the ratings assigned to task A by the corresponding task owner, the first external stakeholder and the second stakeholder are five, six and seven, respectively.

The graphical representation depicts a situation of concern because the task owner corresponding to task A has rated the task low at the rating of five, while the first external stakeholder and the second external stakeholder have rated task A differently and higher than the rating assigned by the task owner.

In FIG. 4d, the ratings assigned to task A by the corresponding task owner, the first external stakeholder and the second external stakeholder are six, five and two, respectively.

The graphical representation depicts a situation of high concern because the task owner corresponding to task A has rated the task at the rating of six, while the first external stakeholder and the second external stakeholder have rated task A differently and lower than the rating assigned by the task owner. Moreover, there is a large difference between the ratings assigned by the first external stakeholder and the second external stakeholder. This large difference indicates a large disconnect between the evaluations performed by the first external stakeholder and the second external stakeholder.

In FIG. 4e, the ratings assigned to task A by the corresponding task owner, the first external stakeholder and the second external stakeholder are three, four and five, respectively.

The graphical representation depicts a huge concern because the task owner corresponding to task A has rated the task low at the rating of three, while the first external stakeholder and the second external stakeholder have rated task A differently and higher than the rating assigned by the task owner. The graphical representation indicates that there is a large disconnect between the evaluations performed by the task owner, the first external stakeholder and the second external stakeholder.

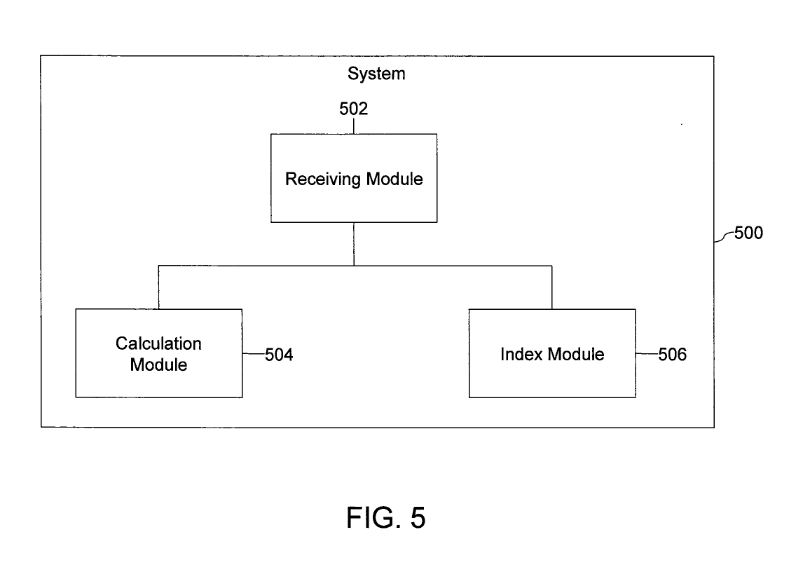

FIG. 5 is a block diagram of a system 500 for determining the quality of a project, in accordance with various embodiments of the invention. System 500 includes a receiving module 502, a calculation module 504 and an index module 506.

Receiving module 502 receives a plurality of ratings corresponding to each of the one or more tasks. The ratings corresponding to a task are assigned by the corresponding task owner and the corresponding external stakeholders. The received ratings corresponding to each task are provided to calculation module 504. Calculation module 504 determines the average of the ratings assigned by the external stakeholders for each task. Calculation module 504 then determines a variation between the average rating and the rating assigned by the task owner for each task. Index module 506 determines an evaluation index for the project, based on the variation corresponding to each task.

Receiving module 502 receives the ratings corresponding to each task performed during the course of the project. The received ratings corresponding to a task are assigned by the corresponding task owner and the corresponding external stakeholders.

The ratings are assigned, based on one or more evaluation criteria. The evaluation criteria include the scope, time duration, cost, quality of the task performed, and so forth. The evaluation criteria are further explained in detail as an exemplary embodiment of the invention in conjunction with FIG. 3a.

Calculation module 504 determines the average of the ratings assigned by the external stakeholders. The average rating is calculated for each task. The calculation of the average rating is further explained in detail as the exemplary embodiment of the invention in conjunction with FIG. 3a.

Calculation module 504 then determines a variation between the calculated average rating and the rating assigned by the task owner. This variation is calculated for each of the tasks. In an embodiment of the invention, the variation is a numerical difference between the average rating and the rating assigned by the task owner. The calculation of the variation is further explained in detail as the exemplary embodiment of the invention in conjunction with FIG. 3a.

Index module 506 determines an evaluation index for the project. To determine the evaluation index, index module 506 calculates the ratio of the variation to the average rating for each task. In an embodiment of the invention, index module 506 calculates the ratio of the difference to the average rating for each task. Index module 506 then calculates the average of the ratio corresponding to each task. The average of the ratios is the evaluation index for the project.

The evaluation index indicates the quality of the project. The evaluation also indicates disconnect between the evaluations performed by the task owners and the external stakeholders. Further, the evaluation index indicates the need for improvement in the quality of work. Furthermore, the calculation of the evaluation is explained in detail with the exemplary embodiment of the invention in conjunction with FIG. 3a.

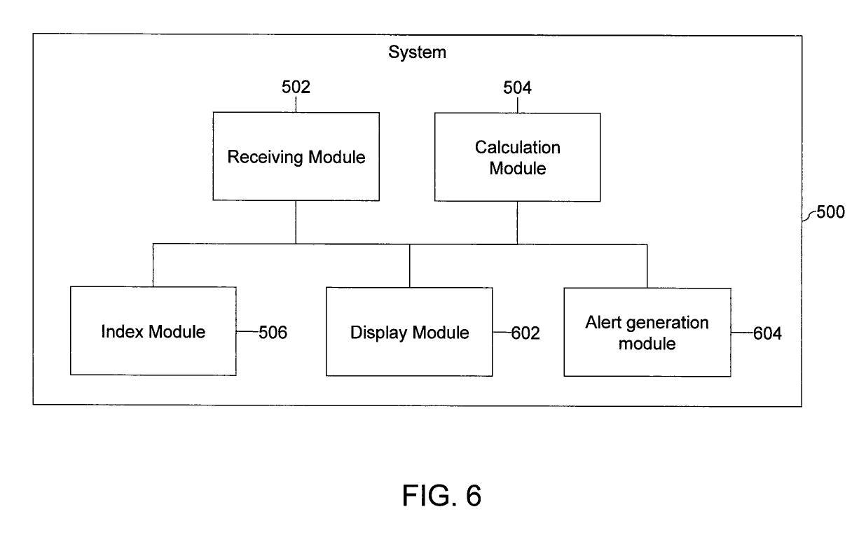

FIG. 6 is a block diagram of a system 500 for determining the quality of a project, according to an embodiment of the invention. System 500 includes receiving module 502, calculation module 504, index module 506, a display module 602 and an alert generation module 604.

Receiving module 502 receives a plurality of ratings corresponding to each of the one or more tasks. The ratings corresponding to a task are assigned by the corresponding task owner and the corresponding external stakeholders. The received ratings corresponding to each task are provided to calculation module 504. Calculation module 504 determines the average of the ratings assigned by the external stakeholders for each task. Calculation module 504 then determines a variation between the average rating and the rating assigned by the task owner for each task. Index module 506 determines an evaluation index for the project, based on the variation corresponding to each task. Receiving module 502, calculation module 504 and index module 506 are further explained in detail in conjunction with FIG. 5.

Display module 602 graphically represents the ratings corresponding to each task. Various graphs enable the task owners and the external stakeholders to quickly analyze disconnect between the evaluations performed for each task. Each task is evaluated at the micro level, for example, each task is evaluated, based on all possible evaluation criteria. The graphical representation of the evaluations enables the senior-level management to quickly analyze the situation. The details of the graphical representation are explained in conjunction with FIGS. 4a to 4e and FIG. 3b.

Alert generation module 604 generates an alert, based on the calculated evaluation index. Alert generation module 604 generates the alert when the evaluation index deviates from the zero value to more than a predefined amount. Such an alert indicates that there is a large disconnect between the evaluations performed by the task owner and the external stakeholders. In an exemplary embodiment of the invention, as explained in detail in conjunction with FIG. 3a, the alert will be generated if the evaluation index becomes greater than ±1.

The system and method described above has a number of advantages. The system determines the quality of the project. The evaluation index indicates a need for improvement in the quality of the task. The system provides transparency among the plurality of stakeholders corresponding to a task of the one or more tasks. Further, the system alerts the task owners and the external stakeholders, based on the evaluation index.

The system for evaluating a project, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer further comprises a microprocessor, which is connected to a communication bus. The computer also includes a memory, which may include Random Access Memory (RAM) and Read Only Memory (ROM). The computer system also comprises a storage device, which can be a hard disk drive or a removable storage drive such as a floppy disk drive, an optical disk drive, etc. The storage device can also be other similar means for loading computer programs or other instructions into the computer system. The computer system also includes a communication unit, which enables the computer to connect to other databases and the Internet through an Input/Output (I/O) interface. The communication unit also enables the transfer as well as reception of data from other databases. The communication unit may include a modem, an Ethernet card, or any similar device which enable the computer system to connect to databases and networks such as Local Area Network (LAN), Metropolitan Area Network (MAN), Wide Area Network (WAN) and the Internet. The computer system facilitates inputs from a user through an input device, accessible to the system through an I/O interface.

The computer system executes a set of instructions that are stored in one or more storage elements, in order to process the input data. The storage elements may also hold data or other information as desired. The storage element may be in the form of an information source or a physical memory element present in the processing machine.

The present invention may also be embodied in a computer program product for evaluating a project. The computer program product includes a computer usable medium having a set program instructions comprising a program code for evaluating a project. The set of instructions may include various commands that instruct the processing machine to perform specific tasks such as the steps that constitute the method of the present invention. The set of instructions may be in the form of a software program. Further, the software may be in the form of a collection of separate programs, a program module with a large program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limit to these embodiments only. Numerous modifications, changes, variations, substitutions and equivalents will be apparent to those skilled in the art without departing from the spirit and scope of the invention, as described in the claims.

What is claimed is:

1. A method for evaluating a project, the project comprising one or more tasks, each of the one or more tasks having a plurality of stakeholders. the plurality of stakeholders comprising a task owner conducting a task of the one or more tasks and one or more external stakeholders, the method comprising:
a. assigning a plurality of ratings corresponding to each of the one or more tasks, each of the plurality of ratings being assigned by a stakeholder of the plurality of stakeholders, the plurality of ratings indicating an evaluation for corresponding task of the plurality of tasks, wherein the plurality of ratings are assigned based on one or more evaluation criteria;
b. determining an average rating of the assigned rating corresponding to each of the one or more external stakeholders, the average rating being calculated for each of the one or more tasks;
c. determining a variation between the average rating and a rating assigned by the task owner, the average rating and the rating assigned by the task owner corresponding to a task of the one or more tasks, the variation being determined for each of the one or more tasks; and
d. determining an evaluation index for the project based on the variation corresponding to each of the one or more tasks, wherein the evaluation index indicates the quality of the project.

2. The method according to claim 1, wherein the one or more evaluation criteria comprise the scope, the time duration, the cost and the quality of the task.

3. The method according to claim 1, wherein the variation is a difference between the average rating and the rating assigned by the task owner.

4. The method according to claim 1, wherein determining the evaluation index comprises calculating a ratio of the variation to the average rating for each of the one or more tasks.

5. The method according to claim 4, wherein determining the evaluation index further comprises calculating an average of the ratio corresponding to each of the one or more tasks.

6. A system for evaluating a project, the project comprising one or more tasks, each of the one or more tasks having a plurality of stakeholders. the plurality of stakeholders comprising a task owner conducting a task of the one or more tasks and one or more external stakeholders, the system comprising:
a. a receiving module configured for receiving a plurality of ratings corresponding to each of the one or more tasks, each of the plurality of ratings being assigned by a stakeholder of the plurality of stakeholders, each of the plurality of ratings indicating an evaluation for corresponding task of the one or more tasks, wherein the plurality of ratings are assigned based on one or more evaluation criteria;
b. a calculation module configured for:
i. determining an average rating of the assigned rating corresponding to each of the one or more external stakeholders, the average rating being calculated for each of the one or more tasks; and
ii. determining a variation between the average rating and a rating assigned by the task owner, the average rating and the rating assigned by the task owner corresponding to a task of the one or more tasks, the variation being determined for each of the one or more tasks; and
c. an index module configured for determining an evaluation index for the project based on the variation corresponding to each of the one or more tasks, wherein the evaluation index indicates the quality of the project.

7. The system according to claim 6, wherein the one or more evaluation criteria comprise the scope, the time duration, the cost and the quality of the project.

8. The system according to claim 6, wherein the variation is a difference between the average rating and the rating assigned by the task owner.

9. The system according to claim 6, wherein the index module determines the evaluation index based on a ratio of the variation to the average rating for each of the one or more tasks.

10. The system according to claim 9, wherein the index module is further configured for calculating an average of the ratio corresponding to each of the one or more tasks.

11. A computer program product for use with a computer, the computer program product comprising a computer usable medium having a computer readable program code embodied therein for evaluating a project, the project comprising one or more tasks, each of the one or more tasks having a plurality of stakeholders. the plurality of stakeholders comprising a task owner conducting a task of the one or more tasks and one or more external stakeholders, the computer readable program code performing:
a. receiving a plurality of ratings corresponding to each of the one or more tasks, each of the plurality of ratings being assigned by a stakeholder of the plurality of stakeholders, each of the plurality of ratings indicating an evaluation for corresponding task of the one or more tasks, wherein the plurality of ratings are assigned based on one or more evaluation criteria;
b. determining an average rating of the assigned rating corresponding to each of the one or more external stakeholders, the average rating being calculated for each of the one or more tasks;
c. determining a variation between the average rating and a rating assigned by the task owner, the average rating and the rating assigned by the task owner corresponding to a task of the one or more tasks, the variation being determined for each of the one or more tasks; and
d. determining an evaluation index for the project based on the variation corresponding to each of the one or more tasks, wherein the evaluation index indicates the quality of the project.

12. The computer program product of claim 11, wherein the one or more evaluation criteria comprise the scope, the time duration, the cost and the quality of the project.

13. The computer program product of claim 11, wherein the variation is a difference between the average rating and the rating assigned by the task owner.

14. The computer program product of claim 11, wherein determining the evaluation index comprises calculating a ratio of the variation to the average rating for each of the one or more tasks.

15. The computer program product of claim 14, wherein determining the evaluation index further comprises calculating an average of the ratio corresponding to each of the one or more tasks.
